(19) United States
(12) Patent Application Publication
(10) Pub. No.: US 2024/0326164 A1
(43) Pub. Date: Oct. 3, 2024

(54) LASER WELDING METHOD AND LASER WELDING APPARATUS

(71) Applicant: SUBARU CORPORATION, Tokyo (JP)

(72) Inventor: Tatsunori MATSUNAGA, Tokyo (JP)

(73) Assignee: SUBARU CORPORATION, Tokyo (JP)

(21) Appl. No.: 18/595,624

(22) Filed: Mar. 5, 2024

(30) Foreign Application Priority Data
Mar. 28, 2023 (JP) 2023-052414

(51) Int. Cl. B23K 26/073; B23K 26/06; B23K 26/21

(52) U.S. Cl. CPC B23K 26/073; B23K 26/0648; B23K 26/21

(57) ABSTRACT

A laser welding method includes applying a laser beam to a welded member in which a first metal plate and a second metal plate formed of a material having a melting point lower than a melting point of the first metal plate are superposed, to weld the first metal plate and the second metal plate. The laser beam is caused to pass through a diffractive optical element configured to reduce a spot diameter of a focal point of the laser beam and then to pass through a condenser lens such that the laser beam has the spot diameter of the focal point of 0.3 mm or less. The laser beam is applied to the first metal plate.

### CROSS-REFERENCE TO RELATED APPLICATION

The present application claims priority from Japanese Patent Application No. 2023-052414 filed on Mar. 28, 2023, the entire contents of which are hereby incorporated by reference.

### BACKGROUND

The disclosure relates to a laser welding method and a laser welding apparatus for use in welding superposed metal plates.

In welding metal plates, laser welding is widely used in a production line for mass-producing products because a time required for the welding is short and productivity is high. In a production line of a vehicle such as an automobile, the laser welding is used to join metal plates constituting a vehicle body.

As the metal plate constituting the vehicle body, a metal plate formed of an iron-based material having a high strength is frequently used. In recent years, along with weight reduction of the vehicle body, a metal plate formed of an aluminum-based material has been increasingly applied to a part of the vehicle body. The laser welding enables not only welding of similar metal materials but also joining of dissimilar metal materials having different melting points. In the production line of the vehicle, there is a demand for using the laser welding to join the metal plate formed of the iron-based materials and the metal plate formed of the aluminum-based materials.

However, when the metal plate formed of the iron-based material and the metal plate formed of the aluminum-based material are laser-welded, generation of an intermetallic compound (IMC) at a bonding interface causes a decrease in a peel strength. Therefore, when joining such dissimilar metals, it is common to provide a step of joining the dissimilar metals using a rivet such as a self-piercing rivet (SPR). From a viewpoint of the productivity, a method of laser-welding dissimilar metals while preventing generation of intermetallic compounds has been developed.

For example, Japanese Unexamined Patent Application Publication (JP-A) No. H4-81288 discloses a method including disposing a clad material in which an iron-based member and an aluminum-based member are stacked, between a first metal plate formed of an iron-based material and a second metal plate formed of an aluminum-based material, and performing laser welding. In this method, in a state in which the iron-based member of the clad material is in contact with the first metal plate and the aluminum-based member is in contact with the second metal plate, the laser welding is performed under welding conditions in which the dissimilar metals are not melted, which prevents the generation of the intermetallic compound.

### SUMMARY

An aspect of the disclosure provides a laser welding method. The laser welding method includes applying a laser beam to a welded member in which a first metal plate and a second metal plate formed of a material having a melting point lower than a melting point of the first metal plate are superposed, to weld the first metal plate and the second metal plate. The laser beam is caused to pass through a diffractive optical element configured to reduce a spot diameter of a focal point of the laser beam and then to pass through a condenser lens such that the laser beam has the spot diameter of the focal point of 0.3 mm or less. The laser beam is applied to the first metal plate.

An aspect of the disclosure provides a laser welding apparatus configured to implement the laser welding method. The laser welding apparatus includes a laser oscillator, a condenser lens, and a diffractive optical element. The laser oscillator is configured to generate a laser beam. The condenser lens is configured to condense the generated laser beam. The diffractive optical element is disposed between the laser oscillator and the condenser lens. The diffractive optical element is configured to reduce a spot diameter of a focal point of the laser beam. The diffractive optical element reducing the spot diameter of the focal point of the laser beam to 0.3 mm or less.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram of a laser welding apparatus for use in a laser welding method according to a first embodiment of the disclosure.

FIG. 2 is a diagram illustrating a welding process for a welded member using the laser welding apparatus according to the present embodiment.

FIG. 3 is a diagram illustrating a welding process for a welded member using a laser welding apparatus of the related art.

FIG. 4 is a diagram illustrating a production line where mixed production is performed using the laser welding apparatus.

FIG. 5A is a plan view of a laser beam applied to a surface of a first metal plate in a laser welding apparatus according to the embodiment.

FIG. 5B is a diagram illustrating a power distribution of the laser beam on a line X-X in FIG. 5A.

FIG. 6A is a plan view of a laser beam applied to a surface of a first metal plate in the laser welding apparatus according to an embodiment.

FIG. 6B is a diagram illustrating a power distribution of the laser beam on a line Y-Y in FIG. 6A.

### DETAILED DESCRIPTION

A laser welding method using a clad material (for example, the method described in JP-A No. H4-81288) is costly because the clad material is used for each portion to be welded, and it is necessary to supply the clad material between two metal plates and hold the clad material and the two metal plates before welding, which lowers productivity.

Therefore, there is a demand for a method capable of achieving a sufficient bonding strength of dissimilar metals by laser welding without disposing a clad material between the dissimilar metals.

It is desirable to provide a laser welding method and a laser welding apparatus capable of improving the bonding strength of dissimilar metals.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

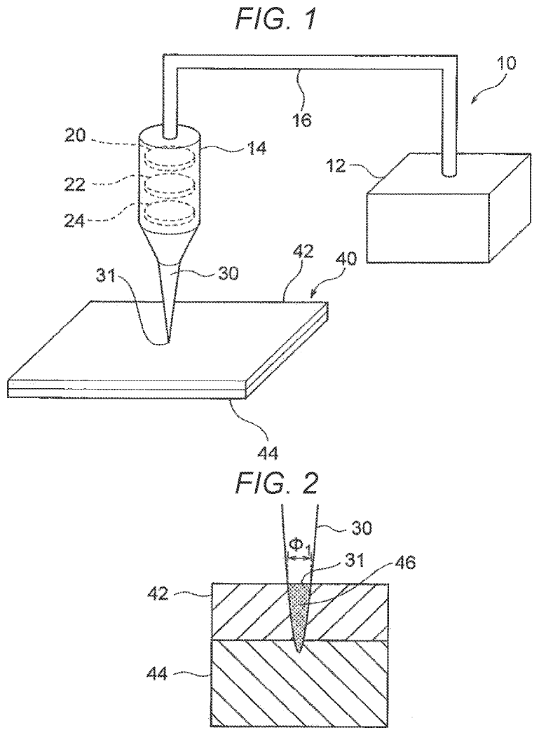

FIG. 1 is a schematic diagram of a laser welding apparatus 10 according to a first embodiment of the disclosure. The laser welding apparatus 10 is an apparatus that applies a laser beam to a welded member 40 including superposed metal plates 42 and 44, to weld the metal plates 42 and 44. The laser welding apparatus 10 according to the present embodiment can be used for welding similar metal materials as well as welding dissimilar metal materials having different melting points. The laser welding apparatus 10 includes a laser oscillator 12 that generates the laser beam, a laser irradiation head 14, and an optical path 16 that couples the laser oscillator 12 and the laser irradiation head 14.

The laser oscillator 12 can output the laser beam serving as a welding heat source. The laser oscillator 12 may include, for example, a light source such as a YAG laser, a CO2 laser, a fiber laser, and a disk laser.

The optical path 16 transmits the laser beam output from the laser oscillator 12 and inputs the laser beam to the laser irradiation head 14. The optical path 16 may have, for example, a structure in which the laser beam is freely curved by an optical fiber and transmitted, or a structure in which the laser beam is reflected by a mirror and transmitted.

The laser irradiation head 14 transmits and outputs the laser beam from the laser oscillator 12 to apply the laser beam to the welded member 40. The laser irradiation head 14 is configured such that the welded member 40 and a welding laser beam 30 to be applied to the welded member 40 can be relatively moved. The laser beam 30 is scanned on the welded member 40 to weld the welded member 40. The laser irradiation head 14 includes a collimator lens 20, a diffractive optical element (DOE) 22, and a condenser lens 24 therein.

The collimator lens 20 collimates the laser beam input via the optical path 16. The laser beam that has passed through the collimator lens 20 is parallel light. The condenser lens 24 converges the collimated laser beam. The laser beam 30 converged by the condenser lens 24 is output to an outside of the laser irradiation head 14 and is applied to the welded member 40.

The diffractive optical element 22 is disposed between the collimator lens 20 and the condenser lens 24. The diffractive optical element 22 includes multiple integrated diffraction gratings having different periods. The diffractive optical element 22 serves as a beam shaper that shapes a beam shape by bending or combining the input laser beam in a direction affected by each diffraction grating. In the present embodiment, the diffractive optical element 22 shapes the beam shape such that a spot diameter of a focal point of the laser beam is reduced. The laser beam that has passed through the diffractive optical element 22 and has been shaped is converged by the condenser lens 24. The diffractive optical element 22 is configured such that the spot diameter of a focal point 31 of the converged laser beam 30 is 0.3 mm or less.

Next, description will be made on a welding method of performing laser welding, using the laser welding apparatus 10, on the welded member 40 in which a first metal plate 42 and a second metal plate formed of a material having a melting point lower than that of the first metal plate 42 are superposed. As illustrated in FIG. 1, the present embodiment welds the first metal plate 42 formed of an iron-based material and a second metal plate 44 formed of an aluminum-based material. In one embodiment, the first and second metal plates 42 and 44 may serve as metal plates having different melting points.

In the laser welding apparatus 10, the welded member 40 is disposed such that the laser beam 30 is applied to a surface of the first metal plate 42. The laser beam output from the laser oscillator 12 of the laser welding apparatus 10 is input to the laser irradiation head 14 via the optical path 16, passes through the collimator lens 20 to be collimated. The laser beam passes through the diffractive optical element 22 to shape the beam shape such that the spot diameter is reduced. Then, the laser beam is converged by the condenser lens 24. The converged laser beam 30 is applied to the welded member 40 such that the focal point 31 is located on a surface of the first metal plate 42.

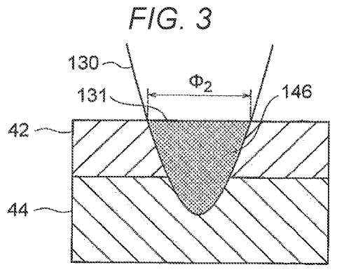

FIGS. 2 and 3 are cross-sectional views illustrating a welding process for the welded member 40. FIG. 2 illustrates a welded portion where the laser welding apparatus 10 according to the present embodiment welds the first and second metal plates 42 and 44. FIG. 3 illustrates a welded portion where a laser welding apparatus of the related art that has no diffractive optical element 22 welds the first and second metal plates 42 and 44. In a welding method of the related art, a laser beam that has been converted into parallel light through a collimator lens is converged by a condenser lens without passing through a diffractive optical element, and is emitted as a welding laser beam 130. On the other hand, as illustrated in FIG. 2, in the welding method according to the present embodiment, the beam is shaped by the diffractive optical element 22, and therefore a spot diameter (p of the focal point 31 of the welding laser beam 30 is reduced. For example, in the method of the related art, a spot diameter p² (that is, the minimum spot diameter p²) of a focal point 131 of the laser beam 130 converged by the condenser lens is 0.6 mm, whereas in the laser welding apparatus 10 according to the present embodiment, the spot diameter (p is 0.2 mm. By reducing the spot diameter (p, a melted portion 46 has a spike shape that is thinner than the shape of a melted portion 146 of the related art.

As described above, in the laser welding method according to the present embodiment, the spot diameter (p of the focal point 31 of the laser beam can be reduced by the diffractive optical element 22. Accordingly, the melted portion 46 where the laser beam 30 melts the welded member 40 has the spike shape, which reduces an amount of the first metal plate 42 melted into the second metal plate 44. As a result, a thickness of an intermetallic compound generated at a bonding interface between the first and second metal plates 42 and 44 can be reduced, which improves a bonding strength between the first and second metal plates 42 and 44, which are dissimilar metals. A method of reducing the amount of the first metal plate 42 melted into the second metal plate 44 by reducing a heat input amount is, for example, a method that changes an output of the laser beam. However, since the minimum value of a spot diameter of a focal point is determined by the performance of the laser oscillator 12, the spot diameter is less likely to be further reduced. There is another method that increases a welding speed in order to reduce the amount of the first metal plate 42 melted into the second metal plate 44. However, heat input control is difficult. In the laser welding apparatus according to the present embodiment, in a state where a laser output and a welding speed are set on the same conditions as those in the apparatus of the related art having no diffractive optical element 22, the amount of the first metal plate 42 melted into the second metal plate 44 can be reduced, the thickness of the intermetallic compound can be reduced, and the bonding strength can be increased.

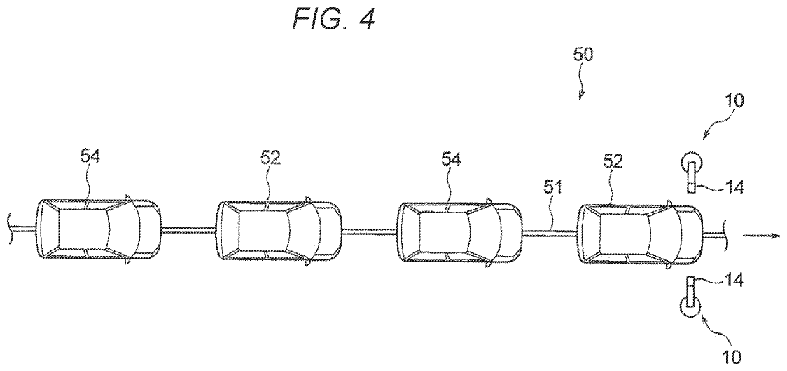

The laser welding apparatus 10 according to the present embodiment can be used for welding similar metals as well as welding dissimilar metals. Therefore, for example, as illustrated in FIG. 4, in a production line 50 in which vehicle bodies 52 each including a steel plate and an aluminum alloy plate and vehicle bodies 54 each simply including a steel plate are conveyed on the same conveying line 51 and are produced in a mixed manner, the vehicle bodies 52 and 54 can be laser welded using the same laser welding apparatus 10. In this manner, by using the laser welding apparatus 10 according to the present embodiment in the mixed production in which welding of similar metals and welding of dissimilar metals are performed on the same production line, it is possible to shorten a takt time of a product and improve manufacturing efficiency.

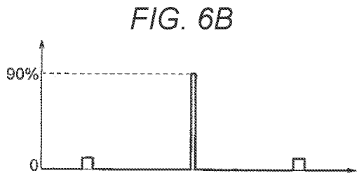

Next, the laser welding apparatus 10 according to a second embodiment will be described. The laser welding apparatus 10 according to the second embodiment differs from the laser welding apparatus 10 according to the first embodiment in a lens shape of the diffractive optical element 22, and the other components are the same as those of the laser welding apparatus 10 illustrated in FIG. 1. In the laser welding apparatus 10 according to the second embodiment, as illustrated in FIG. 6A, a laser beam is shaped by the diffractive optical element 22 to thereby divide the laser beam into one main beam 32 and one or more sub-beams 34 having a power density smaller than that of the main beam 32.

The main beam 32 has a power density capable of welding the first and second metal plates 42 and 44, and is set such that a spot diameter of a focal point of the main beam 32 which has passed through the condenser lens 24 is 0.3 mm or less. The sub-beam 34 has a power density sufficient to simply melt a surface layer of the first metal plate 42, and is formed at least forward in a travel direction of the main beam 32.

In the embodiment illustrated in FIG. 6A, the laser beam is divided into the main beam 32 and the multiple sub-beams 34. The multiple sub-beams 34 are formed into a ring shape surrounding the main beam 32. In the illustrated example, the multiple sub-beams 34 form a circular ring shape. However, the ring shape is not limited to this example, but may be an ellipse shape or a polygonal shape such as a quadrangular shape.

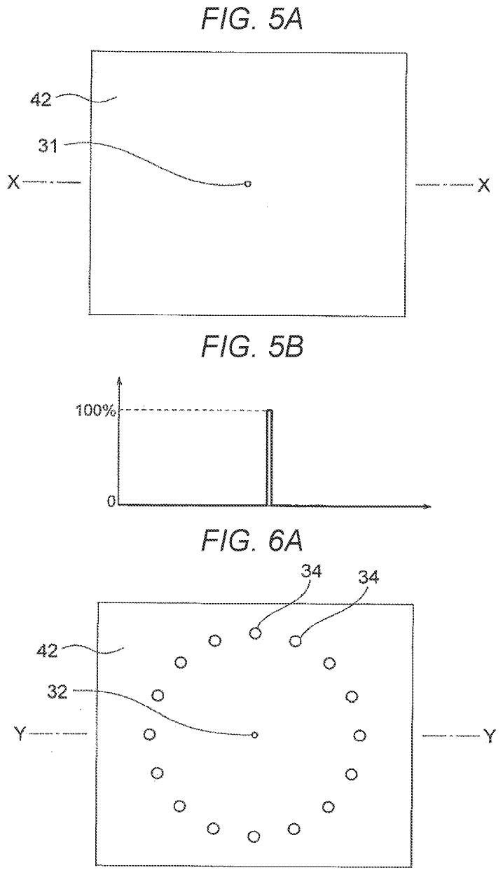

FIG. 5A is a plan view of the laser beam 30 applied to a surface of the first metal plate 42 in the laser welding apparatus 10 according to the first embodiment. FIG. 5B is a diagram illustrating a power distribution of the laser beam on a line X-X in FIG. 5A. FIG. 6B is a diagram illustrating a power distribution of the laser beam on a line Y-Y in FIG. 6A. In FIGS. 5B and 6B, a horizontal axis indicates a position. As illustrated in FIGS. 5A and 5B, in the first embodiment, the laser beam simply includes one beam that performs welding. On the other hand, in the second embodiment, assuming that a total energy density of the laser beam is 100%, the energy density of the main beam 32 is set to approximately 90% of the whole laser beam, and the multiple sub-beams 34 are set to approximately 10% of the whole laser beam. Energy of each of the sub-beams 34 is set to be approximately equal to each other. In this way, the energy density of the main beam 32 is sufficiently higher than that of the sub-beams 34. The main beam 32 is desirably set to be 75% or more of the total energy density of the laser beam. In the second embodiment illustrated in FIG. 6A, a spot diameter of each of the sub-beams 34 is larger than a spot diameter of the main beam 32. The spot diameter of the sub-beam 34 may be equal to or smaller than that of the main beam 32.

The laser welding apparatus 10 which forms the sub-beams 34 is suitably used for performing laser welding for the welded member 40 in which, for example, the first metal plate 42 include an unillustrated plating layer on the surface of the first metal plate 42.

For example, since the sub-beams 34 are formed forward in the travel direction of the main beam 32, after the sub-beams 34 melt the plating layer of the first metal plate 42 and remove plating, the first and second metal plates 42 and 44 can be welded by the main beam 32. When a plating layer is provided, a boiling point of iron differs from that of a metal constituting the plating layer. Therefore, the evaporated plating may enter the melted iron and deteriorate a welding quality. However, since the sub-beams 34 remove the plating, the welding quality can be improved.

As in the example illustrated in FIG. 6A in which the multiple sub-beams 34 surround the main beam 32, no matter which direction the main beam 32 is traveling, the sub-beams 34 are applied forward in the travel direction. Therefore, when the laser welding is performed while changing the travel direction, the welding can be performed while removing the plating layer in any travel direction. Further, application of the sub-beams 34 which is rearward in the travel direction to a region through which the main beam 32 has passed can slowly harden the welded portion rather than rapidly cooling.

The disclosure is not limited to the embodiments described above, and various changes and modifications may be made without departing from the spirit of the disclosure.

1. A laser welding method comprising:
applying a laser beam to a welded member in which a first metal plate and a second metal plate formed of a material having a melting point lower than a melting point of the first metal plate are superposed, to weld the first metal plate and the second metal plate, wherein
the laser beam is caused to pass through a diffractive optical element configured to reduce a spot diameter of a focal point of the laser beam and then to pass through a condenser lens such that the laser beam has the spot diameter of the focal point of 0.3 mm or less, and the laser beam is applied to the first metal plate.

2. The laser welding method according to claim 1, wherein
the first metal plate comprises a plating layer on a surface of the first metal plate,
the diffractive optical element divides the laser beam into a main beam and one or more sub-beams each having a power density smaller than a power density of the main beam,
the main beam welds the first metal plate and the second metal plate, and
the one or more sub-beams are formed at least forward in a travel direction of the main beam, and melt a surface layer of the first metal plate.

3. The laser welding method according to claim 2, wherein
the one or more sub-beams comprise sub-beams, and
the sub-beams are formed into a ring shape surrounding the main beam.

4. A laser welding apparatus configured to implement the laser welding method according to claim 1, the laser welding apparatus comprising:
a laser oscillator configured to generate a laser beam;
a condenser lens configured to condense the generated laser beam; and
a diffractive optical element disposed between the laser oscillator and the condenser lens, the diffractive optical element being configured to reduce a spot diameter of a focal point of the laser beam, the diffractive optical element being configured to reduce the spot diameter of the focal point of the laser beam to 0.3 mm or less.

5. The laser welding apparatus according to claim 4, wherein
the diffractive optical element is configured to divide the laser beam into a main beam and one or more sub-beams each having a power density smaller than a power density of the main beam,
the main beam welds the first metal plate and the second metal plate, and
the sub-beam is formed at least forward in a travel direction of the main beam, and melts only a surface layer of the first metal plate of the first metal plate and the second metal plate.
